(19) United States
(12) Patent Application Publication
(10) Pub. No.: US 2024/0315279 A1
(43) Pub. Date: Sep. 26, 2024

(54) ENRICHED SUGARBEET PULP PRODUCTION

(71) Applicant: KWS SAAT SE & Co. KGaA, Einbeck (DE)

(72) Inventors: César RUANO, Einbeck (DE); Volker UTESCH, Einbeck (DE); Ben BISHOP, Thriplow (GB); Sebastián Jose OJEDA SALAS, Rancagua (CL)

(73) Assignee: KWS SAAT SE & Co. KGaA, Einbeck (DE)

(21) Appl. No.: 18/271,813

(22) PCT Filed: Jan. 13, 2022
(86) PCT No.: PCT/EP2022/050696

§ 371 Date: Jul. 11, 2023

(30) Foreign Application Priority Data
Jan. 13, 2021 (EP) 21151457.5

(51) Int. Cl. A23K 10/30

(52) U.S. Cl. CPC A23K 10/30

(57) ABSTRACT

The present invention relates to a process for making an animal feedstuff composition from a crop comprising Beta vulgaris plants or parts thereof and the animal feedstuff composition made by said process. Further, the invention encompasses a process for producing an enriched milk preferably containing a higher nutrient content, and a system for managing throughput in a production facility for processing a sugar-containing crop material.

### CROSS-REFERENCE TO RELATED APPLICATIONS

This application is a U.S. National Phase of International Patent Application No. PCT/EP2022/050696, filed on Jan. 13, 2022, which claims priority to European Application No. 21151457.5, filed Jan. 13, 2021. The entire contents of these applications are incorporated herein by reference in their entirety.

Beta vulgaris, including sugarbeet varieties/plants, has been used as a feeding crop in dairy farming for a long time due to its advantageous feeding properties. The main advantage was the fact that historically it was the only winter forage available, as the techniques to ensile maize were unknown, hence so-called fodder beet was the way to feed the livestock across the autumn-winter months until the following spring when new grass would be again available.

The current options available to farmers are either (home-grown) fresh/ensiled Beta vulgaris or ready-made dried and/or pressed sugarbeet pulp from the sugar factories.

### BACKGROUND OF THE INVENTION

Beta vulgaris is an energy-rich crop typically having a desirable sugar content, but which imposes the burden of crop management and post-harvest operations on livestock farmers. Crop management of Beta vulgaris is more challenging compared to alternative forage crops such as maize. The main burden is crop establishment and weed control. Harvesting also requires specific machinery not always available. Depending on harvest conditions the roots will carry more or less soil (dirt tare), therefore either dry or wet cleaning would be necessary and afterwards chopping and mixing with another silage crop to ensile. Roots of Beta vulgaris typically have a dry matter (DM) of 18%-30% which may not allow ensiling on its own as the water content is too high and thus another silage crop is usually necessary to increase the average DM content above 30% DM, otherwise a high-quality silage cannot be achieved. In addition, after chopping (after 24-48 hours) the beet root will release a lot of effluent—up to 35-40% of its weight. This effluent needs to be captured or absorbed, which is another reason another silage crop is also required to ensile beet. The alternative could be to harvest once a week for the use fresh beet, but this is laborious and not a very efficient process. In a practical case, either smaller harvesters owned by the growers to harvest once a week (to ensure good preservation of beet in the field) are used or the growers harvest all beets and store it on a clamp (aerobic conditions). However, this is not possible for all climate conditions and regions. Therefore, the use of fresh beet will always be restricted in certain limited geographic areas and for certain periods of time during the year. Accordingly, one of the advantages enabled by the present invention is to provide a new concept to remove the burden of growing the crop for a livestock farmer (who normally has more focus on animals than on crops). Details will be provided in the following sections.

Sugarbeet co-products from the sugar factories, i.e. pressed beet pulp and dried pulp, are easy to use as feedstuff for animals, but are low in sugar content (typically between 1-5% sugar by weight). A typical sugar content of a fresh sugar beet is between about 10 to 20% by weight, which is however not all extractable. Wet pulp produced from the sugar beet has about 1% sugar by weight and pressed pulp obtained by mechanically pressing the wet pulp to remove water contains about 1-2% sugar by weight. Dried pulp obtained by the thermal drying of pressed pulp contains 4-5% sugar by weight. Some factories just produce pressed pulp, others just dried pulp, and many produce both. This depends on the distance between the sugar factory and livestock farmer.

The sugar beet co-products are in high demand among dairy farmers as they are readily digestible and rich in pectin, A highly digestible fiber delivers higher energy to the animal and better fermentation which results also in better rumen health. All these result in higher and more consistent milk production. Due to the very low levels of sugar in these beet co-products, in some instances molasses and/or other externally-sourced ingredients are added to the processed pulp after the sugar has been extracted from the pulp.

There is a continuing need to improve the quality of feedstuff obtained from sugarbeet co-products and produced at a commercial scale for the dairy and other livestock industries. Therefore, the object of the present invention is to provide a process for producing an animal feedstuff composition comprising optimized nutrient contents, including but not limited to a high level of native sugar content, and an animal feedstuff having a high level of native sugar content.

### Wet Pulp

Wet pulp from sugar beets is produced as a co-product of the sugar production process. After receiving and washing the beets in the factory, the sugar beets are cut into fine slices (cossettes) in a beet slicer or chopper. These cossettes are fed into a diffuser to circulate in a cross-current of hot water during the diffusion stage. The diffusion stage results in the production of raw juice, which is further processed downstream to produce sugar, and exhausted cossettes. At the exit of the diffusion, the exhausted cossettes contain a very small amount of sugar, typically around 1% sugar by weight or less.

After the diffusion, the exhausted cossettes, are referred to as wet pulp which contains about 5%-10% of DM. The approximate composition of the dry matter content of the pulp includes 1%-10% sugar (sucrose), 10%-20% crude fiber, 10%-25% pectin, 40% cellulose, 8% crude protein, and 6% ash.

Wet pulp has a high cellulose content as well as other digestible carbohydrates (hemicellulose and pectin for example). Its content in lignin is very low, so that it confers a good digestibility of its organic matter and a good energy value, which is superior to the one of a maize silage.

### Pressed Pulp

Pressed pulp obtained by mechanically pressing the wet pulp can be delivered either in bulk or in bales. The pressed pulp typically contains about 20%-30% DM after removal of water.

### Dried Pulp

The pressed pulp can be further processed to produce dried pulp having typically 85%-95% DM. Different drying methods can be used to remove water thermally using rotary, tray or belt driers, such as direct high temperature drying using fossil fuels, low temperature drying using fossil fuels or waste heat and steam drying as well as solar drying. Some factories just produce pressed pulp, others just dried pulp, and many produce both. This depends in many cases on the logistics of supplying the livestock farmers.

The dried pulp is normally sold in pellets which are easy to store and can be transported along large distances, and even by sea freight.

### Pectin

Sugarbeets have a unique fiber composition compared to other crops, notably the pectin content (typically 10-25% of the dry matter). Pectin is highly digestible and degraded slowly and continuously in the rumen, in which energy is supplied over long period.

With slower fermentation, the pH of the animal's rumen does not change significantly, staying at about pH 6, thereby reducing the risk of acidosis.

Pectin provides favorable conditions to fiber degradation microbes (which are not very acid tolerant). Furthermore, pectin stimulates microbial protein synthesis and lower milk urea levels. Thus, pectin is an ideal component of starch- or sugar-rich feedstuffs due to the fermentation pattern and the resulting rumen synchronization. Feedstuff including pectin has a positive effect on milk protein, based on better rumen fermentation by optimizing the rumen function.

### SUMMARY OF THE INVENTION

The present application is summarized as follows:

One aspect of the invention is to provide a process for making an animal feedstuff composition comprising the steps of:
i. providing a crop comprising Beta vulgaris plants or parts thereof having a dry matter content greater than about 18% by weight;
ii. cutting the crop into pieces;
iii. conveying the pieces into a diffusion apparatus to produce a fluid and a pulp, said pulp comprising a native sugar content at about 15% to about 60% by weight of the dry matter of the pulp;
iv. removing the pulp from the diffusion apparatus; and
v. processing the pulp to form the feedstuff composition;
   optionally further comprising the step of analyzing the crop to determine a sugar concentration of the crop, preferably wherein the sugar concentration of the crop is determined after cutting the crop into pieces;
   optionally further after removing the pulp from the diffusion apparatus, the pulp is pressed to form a pressed pulp, preferably wherein the pressed pulp is dried to form a dried pulp, more preferably the dried pulp is pelletized and/or the dried pulp is in the form of shreds;
   optionally further comprising the step of analyzing the pulp to determine a sugar concentration of the pulp.

The present invention is directed to a process of making an animal feedstuff composition comprising the steps of: providing a crop comprising Beta vulgaris plants or Beta vulgaris varieties having a dry matter content greater than about 18% by weight; cutting the crop into pieces; conveying the pieces into a diffusion apparatus to produce a fluid and a pulp, said pulp comprising sugar at about 15%-60% by weight of the dry matter of the pulp; removing the pulp from the diffusion apparatus; and processing the pulp to form the feedstuff composition. After removing the pulp from the diffusion apparatus, the pulp may be pressed to form a pressed pulp. The pressed pulp may be dried to form a dried pulp, and the dried pulp may be used directly in the form of shreds, or the dried pulp may be further processed into pellets.

The process may comprise the step of analyzing the crop to determine a sugar concentration of the crop. The sugar concentration of the crop may be determined by spectrometry. The spectrometry may be performed by a spectroscopic method selected from the group consisting of: infrared spectroscopy; mid-infrared spectroscopy; near infrared spectroscopy; Raman spectroscopy; hyperspectral imaging; refractometry; polarimetry; and a combination thereof. The sugar concentration of the crop may be determined after cutting the crop into pieces.

The analysis described above may also or alternatively be used to analyze the pulp to determine a sugar concentration of the pulp.

Another aspect of the present invention is to provide an animal feedstuff composition made by the above-mentioned process.

The present invention is further directed to an animal feedstuff composition made by the process described above. The dry matter content of the feedstuff composition may be between about 5 and 95% by weight, or between about 30-85% by weight. The sugar content of the dry matter content of the feedstuff composition may be between about 0 and 60% by weight, or between about 0 and 30% by weight. The feedstuff composition may further comprise a nutritional component, which may be a digestible fiber including pectin. The ratio of the sugar to the pectin in the feedstuff composition may range from about 1 to about 100% by weight.

The present invention is additionally directed to a process for producing an enriched milk, comprising feeding the animal feedstuff composition to a milk-producing animal, and thereafter obtaining milk from the animal. The milk from the animal may contain a higher nutrient content compared to a milk from an animal who has not been fed the feedstuff, wherein the higher nutrient content is selected from the group consisting of a higher fat content, a higher protein content, and a combination thereof.

The present invention is also directed to an animal feedstuff composition comprising from about 5% to about 95% processed Beta vulgaris dry matter, wherein the dry matter comprises from about 0% to about 60% sugar. As used herein, “processed Beta vulgaris dry matter” shall mean dry matter that is produced by processing the crop through an apparatus, as contrasted with directly feeding fresh or raw unprocessed Beta vulgaris crops to an animal. The dry matter of the feedstuff composition may comprise from about 0% to about 100% by weight digestible fiber. The digestible fiber may comprise from about 0% to about 100% by weight pectin. The ratio of the sugar to the pectin in the feedstuff composition may range from about 1 to about 100% by weight. The feedstuff may be used to produce an enriched milk, by feeding the feedstuff to a milk-producing animal, and obtaining milk from the animal. The milk from the animal may contain a higher nutrient content compared to a milk from an animal who has not been fed the feedstuff, wherein the higher nutrient content is selected from the group consisting of a higher fat content, a higher protein content, and a combination thereof.

The present invention is further directed to a system for managing throughput in a production facility for processing a sugar-containing crop material, comprising a first detection apparatus to detect a dry matter content and sugar content of the crop material; a second detection apparatus in communication with a fluid-based diffusion apparatus to detect a processed sugar content of the fluid within the diffusion apparatus when the crop material is in the diffusion apparatus, said diffusion apparatus having at least a plurality of operational modes; a controller for controlling the operation of diffusion apparatus in each operational mode; and a memory and processor configured to: (i) receive the dry matter content and the processed sugar content from the first and second detectors; (ii) compare the dry matter content and the processed sugar content; (iii) generate a comparison value; (iv) determine whether the comparison value meets a threshold processed sugar yield target; and (v) transmit a signal to the controller for maintaining or changing the operational mode of the diffusion apparatus based on the determination step (iv).

In a further aspect of the invention, a system for managing throughput in a production facility for processing a sugar-containing crop material, comprising; a first detection apparatus to detect a dry matter content and sugar content of the crop material; a second detection apparatus in communication with a fluid-based diffusion apparatus to detect a processed sugar content of the fluid within the diffusion apparatus when the crop material is in the diffusion apparatus, said diffusion apparatus having at least a plurality of operational modes; a controller for controlling the operation of diffusion apparatus in each operational mode; and a memory and processor configured to:
i. receive the dry matter content and the processed sugar content from the first and second detectors;
ii. compare the dry matter content and the processed sugar content;
iii. generate a comparison value;
iv. determine whether the comparison value meets a threshold processed sugar yield target; and
v. transmit a signal to the controller for maintaining or changing the operational mode of the diffusion apparatus based on the determination step (iv).

In the above-mentioned system, the threshold processed sugar yield target may be generated by a second processor, and the second processor may be configured to:
a. receive a weight input indicating the quantity of the crop material;
b. receive the dry matter content and sugar content from the first detection apparatus; and
c. determine the threshold processed sugar yield target based on the weight input and the dry matter content.

The first detection apparatus in the system may comprise a measurement apparatus for measuring a sugar content of the crop material. The measurement apparatus may use spectrometry to measure the sugar content. The spectrometry may be done by a spectroscopic method selected from the group consisting of infrared spectroscopy; mid-infrared spectroscopy; near infrared spectroscopy; Raman spectroscopy; hyperspectral imaging; refractometry; polarimetry; and a combination thereof.

The system may include a third detection apparatus configured to detect a protein, fiber or other non-sugar component of the pulp produced in the diffusion apparatus.

The system may include a second processor to generate the threshold processed sugar yield target. The second processor may be configured to receive a weight input indicating the quantity of the crop material; receive the dry matter content and sugar content from the first detection apparatus; and determine the threshold processed sugar yield target based on the weight input and the dry matter content.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, explain the principles of the disclosed technology. In the drawings:

FIG. 1 is a key to defining process elements.

FIG. 2 is a schematic representation of an embodiment of a sugar factory process model.

FIG. 3 is a schematic representation of one embodiment of a revised sugar factory process model, indicating in which steps the revisions are made (indicated in numbered circles).

### DETAILED DESCRIPTION

In one aspect of the present invention, an enriched beet pulp is provided.

In another aspect of the present invention, enriched beet pulp according to the present invention is used as animal feedstuff, which may also be known as feeding material, feed, raw material, ingredient, by-product, and co-product.

In a further aspect of the present invention is creating and establishing a sugar-rich animal—particularly dairy—feeding alternative based on partially extracted, non-exhausted sugar beet cossettes or other fine pieces.

The product according to the present invention is suitable for feeding beef and dairy cattle and other livestock like buffalo, sheep, goats and pigs and the like, as well as poultry.

The cossette form of cut beets is used in an industrial sugar extraction process. Cossettes are generally defined as long, thin strips of sliced beets. The quality of cossettes can be or may be measured by a Silin Number, which is the length in meters of 100 g of fresh cossettes. Cossettes are a particular form to enhance and ease the sugar extraction process. While there may be some variation, cossettes are fairly consistent in size and quality across different factories within the natural variability of the sugarbeet being processed. Although they can vary slightly on size, they are pretty similar across different factories. For the sugar industry slicing cossettes is common practice. These are optimized to provide a large surface area for diffusion combined with mechanical strength for pressing to remove water. Typical values for Silin Numbers in a commercial production system may range from about 7 to about 20.

However, the form of the sugar beet used to make the feed according to the present invention is not limited to cossettes. Other forms of cut sugar beets include sliced, chopped, shredded, and the like. One aspect of the present invention is providing a sugar-rich animal feeding alternative which is easy to use, highly nutritious as well as palatable, and results in better milk quality, and which can be produced at a commercial scale.

Milk quality refers to the improved/enhanced content of milk solids such as fat and protein. Feeding products which are rich in native sugar, such as the enriched sugar beet feedstuff described herein, provides the animal with the nutritional and dietary support needed to produce higher quality milk. The nutritional profile of the feedstuff is based on primarily sugar, which provides energy content as an alternative to starch. Both are carbohydrates and can be used by the animal as energy source to produce milk or to gain weight, but they are different and complementary. The animal needs both sources of energy. Also, fiber is an important element of feedstuff to ensure stable gut or rumen health. Sugar beet pectin, being highly digestible, helps to support the animal's overall health. The feedstuff of the present invention provides ease of use. As an example, the dairy farmer receives a product ready to use fresh directly into the TMR mixer (TMR: total mixed ration) to formulate the daily ratio to feed the cows or to be ensiled. “TMR” means a well-mixed and complete dairy diet. TMR's are properly prepared using a Mixer-Wagon. Many times, farmers use just the name “Unifeed” to name the mixing machinery. The farmer therefore is released of the burden of growing Beta vulgaris, which is a highly technical crop that requires attention to detail and is more challenging to grow than maize or other alternative crops. If crop management for Beta vulgaris is more complex than alternatives like maize, harvest and post-harvest operations are far more complex too. At the end, it is easier for the farmer to get access to a sugar-rich feeding product by using the enriched beet feedstuff of the present invention.

In one aspect of the present invention, the amount of pectin is in the range 0-100% by weight of enriched pulp.

In another aspect of the invention, the amount of sugar (sucrose and different saccharides) is in the range of 4 to 18% by weight of the enriched beet feedstuff in a pressed pulp, and about 4% to 50% by weight of a dried pulp.

The present invention further provides a new market segment for value-added animal feed product, which provides the flexibility to process sugar beets into different products to optimize resource use, improve throughput, and respond to changing market demands, harvest quality or storage conditions. One aspect of the invention is to introduce a new type of sugar beet feeding product, in which instead of extracting sugar from the beet at typical levels, the sugar beet feeding product has an increased amount of native sugar content retained in the pressed pulp in the range of 4-18% by weight. This enriched pulp would then be distributed to the customers via existing formats and distribution channels.

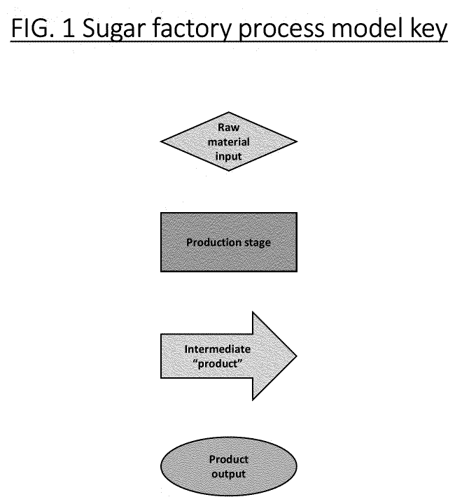

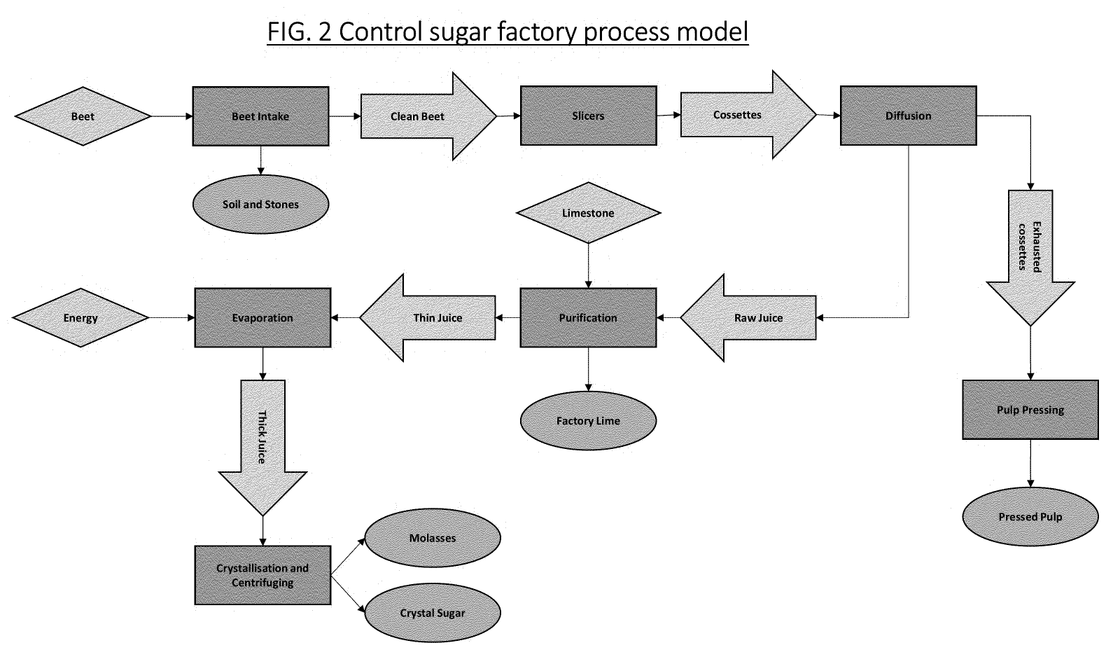

A typical sugarbeet extraction process is shown in FIGS. 1 and 2. FIG. 1 provides a key to various operations in the process, and FIG. 2 shows the relationship of the various operations in a conventional process. Referring to FIG. 2, the following definitions apply:

### Production Stage Definitions

Beet intake—cleaning of beet ex field and movement into sugar factory before slicing
Slicers—slice cleaned beet into cossettes for diffusion
Diffusion—removal of sugar (and non-sugars) from cossettes
Pulp presses—mechanical removal of water by pressing cossettes after diffusion
Purification—removal of non-sugar impurities from juice before evaporation
Evaporation—removal of water from juice before crystallisation
Crystalisation and centrifuge—removal of sugar from juice

### Product Output Definitions

1. Soil and stones
2. Pressed pulp
   fibre from beet
   production c. 5% on beet sliced (i.e., 1 tonne of beet gives 50 kg pressed pulp)
   c. 25% dry matter by weight
   c. 2% sugar by weight
   can be dried to make dried beet pulp with much higher dry matter content of >85% by weight
3. Factory lime
   calcium carbonate containing impurities removed from juice
4. Crystal sugar
   pure sucrose
   production c. 15% beet sliced (i.e., 1 tonne beet gives 150 kg sugar)
5. Molasses
   Sugar syrup where it is no longer economical to extract sugar
   c. 10% of sugar in beet ends in molasses

### Intermediate Product Definitions

1. Clean beet—beet with soil, stones and weed trash removed
2. Cossettes—sliced beet optimized for surface area (for diffusion) and mechanical strength (for pulp pressing)
3. Exhausted cossettes—cossettes with sugar and some non sugars removed
4. Diffused cossettes—cossettes with sugar and some non sugars partially removed
5. Raw juice—thin liquor containing sugar (c. 14% w/w) and non sugar impurities (2% w/w)
6. Thin Juice—thin sugar with impurities removed
7. Thick juice—thick sugar syrup (c. 23% water) with impurities and water removed

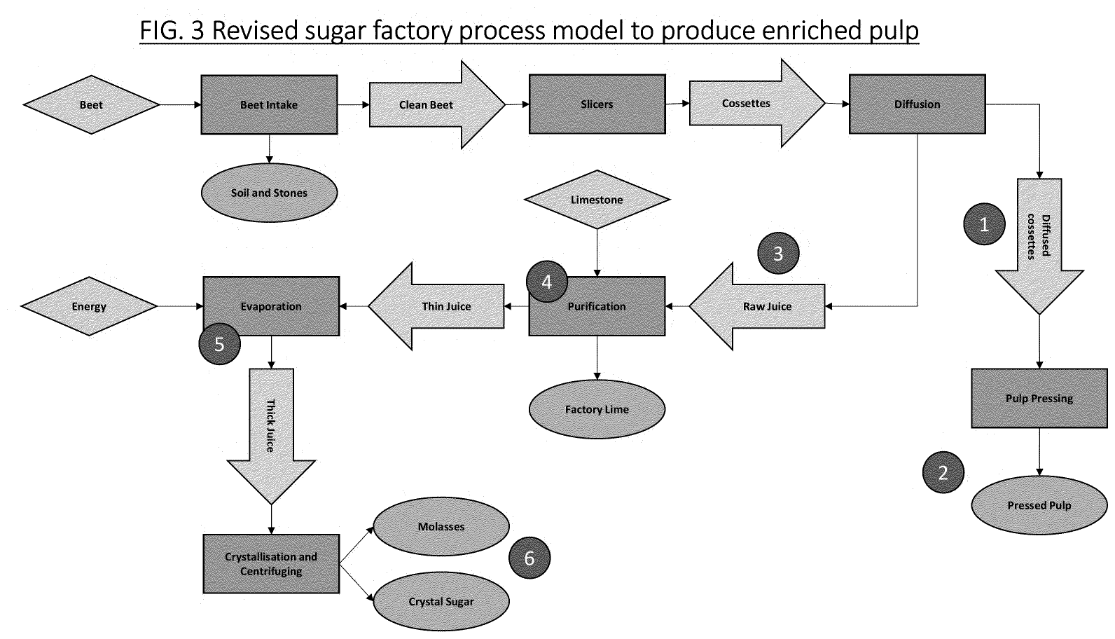

The present invention provides a method or industrial process to produce enriched beet pulp through the partial extraction of sugar from cossettes as shown in FIG. 3. FIG. 3 shows the changes to a conventional process resulting from the process of the present invention. The numbers in FIG. 3 refer to the following changes from a conventional process:
1. Reduced extraction in diffusion leads to:
   an increase in diffused cossettes tonnes to pulp presses
   an increase in sugar and non-sugar tonnes in diffused cossettes
2. Increased diffused cossettes and sugar content:
   removes water from raw juice
   increases pressed pulp sugar content and production—Enriched Pulp
3. Reduced extraction in diffusion leads to:
   lower raw juice flow
   less non sugars in raw juice
4. Reduced raw juice flow and non-sugars leads to:
   reduced lime inputs for purification and output of factory lime product
   reduced thin juice flow
5. Reduced thin juice flow and non-sugars leads to:
   reduced water evaporation
   lower energy input
6. Reduced extraction in diffusion leads to:
   less sugar passing to purification, evaporation and crystallisation=lower sugar production
   less non sugars passing to purification, evaporation and crystallisation=lower molasses production

It is to be noted that the foregoing assumptions are for the same fixed amount of beet entering the factory. It is possible, within the scope of the invention, to increase the amount of beet entering the factory to deliver the same sugar output but with increased pressed pulp production. This increase would not require an additional investment in diffusion, purification, or evaporation capacity. Finally, with an increased amount of beet entering the factory, it is predicted that the purification and evaporation operations will benefit from the reduction in non-sugars and water.

As described above, the process involves extraction or diffusion in a conventional sugar production diffuser apparatus, through which sugar-containing juice is obtained from the cossettes by a combination of leaching and cell-membrane dialysis or disruption. This process is well known to those skilled in the art and is described in Beet-Sugar Technology, 2^{nd} Edition, 1 Jan. 1971, edited by R. A. McGinnis. The cossettes are conveyed into the apparatus, to which water is added to facilitate the diffusion of sugar from the cossettes. Upon operation of the apparatus, the cossettes release components, including sugar, into the water, which is referred to as “diffusion juice,” “raw juice,” or simply “juice”. The ratio of the weight of the sugar-bearing juice drawn from the diffuser apparatus to the weight of the cossettes introduced into the apparatus is called the “diffuser draft” or simply “draft.” Increased draft requires the introduction of additional water into the process. In a typical sugar production process, the draft may range from 100% to 150%, in other words, the weight of the sugar-bearing juice typically weighs at least the same as, or exceeds the weight of, the cossettes conveyed into the diffusion apparatus.

The diffuser apparatus operates at an elevated temperature to facilitate the extraction/diffusion process. Sugar extraction is performed at temperatures above 50° C. to achieve denaturing of the cellular structure, thereby releasing sugar into the juice during the extraction/diffusion process. In conventional processes, a preferred operating temperature is greater than 70° C. to facilitate cellular denaturation.

To produce the animal feedstuff composition of the invention, it was discovered that feedstuff with an increased level of retained native sugar content can be produced at a commercial scale. As used herein, “native sugar content” refers to the sugar content within the beet pulp after diffusion which has not been extracted out and/or is not later added back to the pulp in the form of molasses or from other external sources. The increased level of native sugar content obtained by the partial extraction of sugar from the sugarbeet is beneficial as feedstuff as it provides a high level of nutrients in the feedstuff without requiring supplementation, thereby reducing costs and increasing operational efficiency for the livestock producer. While not intending to be bound by theory, it is believed that the partial extraction of sugar, resulting in “diffused cossettes,” as compared to “exhausted cossettes” (from which nearly all of the sugar has been extracted), has several key process benefits:
The retention time of the cossettes in the diffuser may be reduced meaning a potential increase in throughput and/or a reduction in fresh water make up to the diffuser (so-called draft) meaning less water will be required to be evaporated later in the process;
Reduced extraction in diffusion leads to an increase in diffused cossettes tonnes to pulp presses (wet pulp) and an increase in sugar and non-sugar tonnes in diffused cossettes (wet pulp):
Increased diffused cossettes and sugar content means there is reduced raw juice flow, less water and non-sugars in raw juice and increased pressed pulp sugar content and production—the Enriched Pressed Pulp product;
Reduced raw juice flow and non-sugars results in fewer impurities to be removed meaning reduced lime inputs for purification and also reduced thin juice flow to the evaporation process;
Reduced thin juice flow and non-sugars means there is less water to evaporate—this has the direct result of reducing energy input, emissions and costs.

In one embodiment, the Enriched Pressed Pulp product according to the invention has the properties listed in Table 1 as compared to the output in a conventional sugarbeet process.

TABLE 1
Composition by weight in sugarbeet, wet pulp, pressed pulp
and dried pulp (% in w/w)

| | | | | Conventional | Enriched |
|---|---|---|---|---|---|
| | | Conventional | Conventional | Dried | Pressed |
| | Sugarbeet | Wet Pulp | Pressed Pulp | Pulp | Pulp |
| Dry matter | 18-30 | 5-10 | 20-30 | 85-95 | 20-30 |
| Water | 70-80 | 90-95 | 70-80 | 10-15 | 70-80 |
| Sugar | 10-20 | 1 | 1-2 | 4-5 | 4-18 |
| Non-sugar | 10-15 | 4-9 | 18-28 | 80-85 | 10-20 |
| components | | | | | |

All percentages presented herein are on a weight basis, identified as % or % w/w, unless otherwise indicated. The dry matter content of the crop, sometimes referred to as “DM”, comprises the non-water content of the crop. The term “sugar” refers to sucrose, saccharose, and any other nutritive saccharides present in the crop. “Non-sugar components” include the fiber and protein present in the crop.

The present invention has the following inventive motivation and resulting advantages. Farmers gain access to a new source of high-energy, native sugar-based feedstock product. It has been proven that sugar-rich diets for dairy livestock will trigger higher milk solids, and creameries pay farmers a premium based on milk solids content. Sugar production factories may open up a new “premium” feedstock market segment.

The new type of feedstock is easy to use for the livestock farmer yet offers the full advantages of sugarbeet feeding. Scientific experiments have shown that feeding ensiled or fresh beet leads to significant improvements in milk quality especially in terms of fat content. The present invention offers the livestock farmer an enriched sugarbeet feedstock that has an improved nutritive content and yet is easier to use as compared to conventional Beta vulgaris-based feedstock products.

At the same time, the invention offers the sugar factories or other processing facilities a swing capacity option to buffer volatility and quickly respond to changing market needs. Swing capacity means the same asset can “swing” its processes into different products (i.e., adjust diffusion conditions to produce more or less sugar and/or enriched beet pulp) to exploit high value markets. Different territories may be interested in different swing capacity options. An example of swing capacity is the Brazilian sugar industry and their admired swing capacity for production of ethanol and/or sugar.

According to the present invention, it is possible to increase the amount of sugarbeet entering the factory to deliver the same sugar output but with increased enriched pressed pulp production. This increase would not require investment in diffusion, purification or evaporation capacity. On the other hand, with increased beet entering the factory, benefits in purification and evaporation from reduced non-sugars and water can be still achieved. Increased sugarbeet input means that the factory can maintain sugar output and increase animal feedstock output so can always be operating efficiently.

Another aspect of the invention is to enable the sugar factories or other processing facilities to use Beta vulgaris plants or parts thereof or Beta vulgaris varieties or parts thereof having various sugar content and impurity content levels. As used herein, “impurity” and “impurities” refer to non-sugar nutrients present in the crop. For example, some varieties, while having a desired DM content or sugar content, may include higher levels of impurities such as non-sugar nutrients, crude protein or other components as compared to varieties with lower levels of impurities. Such varieties can be processed in accordance with the invention to produce a high protein feedstuff, which may serve to enhance the nutrient content of the milk produced by animals that consume the feedstuff. This aspect of the invention enables the use of a broader range of Beta vulgaris varieties that can produce a nutritional source of protein, which may be non-GMO protein, in the enriched feedstock for use in the dairy and other industries.

### EXAMPLES

### Example 1

In Example 1, the same amount of sugarbeet was processed through a conventional production system (the “Current diffusion model) as well as a system in accordance with the present invention (the “Enriched pulp diffusion model”). The data are summarized in Tables 2a and 2b. For each model, the inputs, outputs, and products are listed.

TABLE 2a
Current difussion model
For every tonne of beet

| | | |
|---|---|---|
| 150 | kg crystal sugar | Pressed pulp @ 15% beet sliced |
| 45 | kg molasses | Sugar @ 15% beet sliced |
| 150 | kg pressed pulp | Molasses @ 10% SIM, 75% solids and 50% pol |

| | | | |
|---|---|---|---|
| | Tonnes | Tonnes | Tonnes non |
| Tonnes | sugar | water | sugars |

Inputs

| | | | | |
|---|---|---|---|---|
| Beet sliced | 100 | 17 | 72 | 10 |
| Diffusion supply water | 30 | 0 | 30 | 0 |
| Pulp Press Water | 15 | 0.15 | 15 | 0.15 |
| Total | 145 | 17.15 | 117 | 10.15 |

Outputs

| | | | | |
|---|---|---|---|---|
| Raw Juice | 120 | 16.8 | 100.8 | 2.4 |
| Pressed pulp | 15 | 0.3 | 11.25 | 3.45 |
| Losses | 10 | 0.05 | 4.95 | 4.3 |
| Total | 145 | 17.15 | 117 | 10.15 |

Products

| | | | | |
|---|---|---|---|---|
| Sugar | 15.00 | 15.00 | 0.00 | 0 |
| Molasses | 4.53 | 1.70 | 1.13 | 1.70 |
| Pressed Pulp (as DM) | 3.75 | 0.30 | 11.25 | 3.45 |
| Total | | 17.00 | 12.38 | 5.15 |

TABLE 2b
Enriched pulp diffusion model (same beet input)
For every tonne of beet

| | | |
|---|---|---|
| 130 | kg crystal sugar | Pressed pulp @ 30% beet sliced |
| 23 | kg molasses | Sugar @ 13% beet sliced |
| 300 | kg pressed pulp | Molasses @ 5% SIM, 75% solids and 50% pol |

| | | | |
|---|---|---|---|
| | Tonnes | Tonnes | Tonnes non |
| Tonnes | sugar | water | sugars |

Inputs

| | | | | |
|---|---|---|---|---|
| Beet sliced | 100 | 17 | 72 | 10 |
| Diffusion supply water | 30 | 0 | 30 | 0 |
| Pulp Press Water | 15 | 0.15 | 15 | 0.15 |
| Total | 145 | 17.15 | 117 | 10.15 |

Outputs

| | | | | |
|---|---|---|---|---|
| Raw Juice | 100 | 14.5 | 84.5 | 1.5 |
| Pressed pulp | 30 | 2.7 | 22.5 | 4.8 |
| Losses | 15 | −0.05 | 10 | 3.85 |
| Total | 145 | 17.15 | 117 | 10.15 |

Products

| | | | | |
|---|---|---|---|---|
| Sugar | 13.00 | 13.00 | 0.00 | 0 |
| Molasses | 2.27 | 0.85 | 0.57 | 0.85 |
| Enriched Pressed Pulp | 7.50 | 2.70 | 22.5 | 4.8 |
| (as DM) | | | | |
| Total | | 16.55 | 23.07 | 5.65 |

### Example 2

In Example 2, the sugarbeet input was increased in the Enriched pulp diffusion model system in accordance with the present invention as compared to the conventional production system. The data are shown in Tables 3a and 3b.

TABLE 3a
Current difussion model
For every tonne of beet

| | | |
|---|---|---|
| 150 | kg crystal sugar | Pressed pulp @ 15% beet sliced |
| 45 | kg molasses | Sugar @ 15% beet sliced |
| 150 | kg pressed pulp | Molasses @ 10% SIM, 75% solids and 50% pol |

| | | | |
|---|---|---|---|
| | Tonnes | Tonnes | Tonnes non |
| Tonnes | sugar | water | sugars |

Inputs

| | | | | |
|---|---|---|---|---|
| Beet sliced | 100 | 17 | 72 | 10 |
| Diffusion supply water | 30 | 0 | 30 | 0 |
| Pulp Press Water | 15 | 0.15 | 15 | 0.15 |
| Total | 145 | 17.15 | 117 | 10.15 |

Outputs

| | | | | |
|---|---|---|---|---|
| Raw Juice | 120 | 16.8 | 100.8 | 2.4 |
| Pressed pulp | 15 | 0.3 | 11.25 | 3.45 |
| Losses | 10 | 0.05 | 4.95 | 4.3 |
| Total | 145 | 17.15 | 117 | 10.15 |

Products

| | | | | |
|---|---|---|---|---|
| Sugar | 15.00 | 15.00 | 0.00 | 0 |
| Molasses | 4.53 | 1.70 | 1.13 | 1.70 |
| Pressed Pulp (as DM) | 3.75 | 0.30 | 11.25 | 3.45 |
| Total | | 17.00 | 12.38 | 5.15 |

TABLE 3b
Enriched pulp diffusion model (same beet input)
For every tonne of beet

| | | |
|---|---|---|
| 130 | kg crystal sugar | Pressed pulp @ 30% beet sliced |
| 23 | kg molasses | Sugar @ 13% beet sliced |
| 300 | kg pressed pulp | Molasses @ 5% SIM, 75% solids and 50% pol |

| | | | |
|---|---|---|---|
| | Tonnes | Tonnes | Tonnes non |
| Tonnes | sugar | water | sugars |

Inputs

| | | | | |
|---|---|---|---|---|
| Beet sliced | 115.4 | 19.618 | 83.088 | 11.54 |
| Diffusion supply water | 30 | 0 | 30 | 0 |
| Pulp Press Water | 15 | 0.15 | 15 | 0.15 |
| Total | 160.4 | 19.768 | 128.088 | 11.69 |

Outputs

| | | | | |
|---|---|---|---|---|
| Raw Juice | 115.4 | 16.733 | 97.513 | 1.731 |
| Pressed pulp | 34.62 | 3.1158 | 25.965 | 5.5392 |
| Losses | 10.38 | −0.0808 | 4.61 | 4.4198 |
| Total | 160.4 | 19.768 | 128.088 | 11.69 |

Products

| | | | | |
|---|---|---|---|---|
| Sugar | 15.00 | 15.00 | 0.00 | 0 |
| Molasses | 2.62 | 0.98 | 0.65 | 0.98 |
| Enriched Pressed Pulp | 8.66 | 3.12 | 25.965 | 5.5392 |
| (as DM) | | | | |
| Total | | 19.10 | 26.62 | 6.52 |

### Example 3

A commercial scale process model was developed, based on Examples 1 and 2, and the expected results from the models are summarized in the following tables.

TABLE 4a
Control Model-pressed pulp production
For every tonne of sugar beet:

| | |
|---|---|
| 162 | kg crystal sugar |
| 30 | kg molasses |
| 202 | kg pressed pulp |

| | | | |
|---|---|---|---|
| | Tonnes | Tonnes | Tonnes non |
| Tonnes | sugar | water | sugars |

Inputs

| | | | | |
|---|---|---|---|---|
| Beet sliced | 100.00 | 18.00 | 75.00 | 7.00 |
| Diffusion supply water | 21.63 | — | 21.63 | — |

Outputs

| | | | | |
|---|---|---|---|---|
| Raw Juice | 101.43 | 17.72 | 82.32 | 1.39 |
| Pressed Pulp | 20.20 | 0.28 | 14.14 | 5.78 |

Products

| | | | | |
|---|---|---|---|---|
| Sugar | 16.22 | 16.22 | — | — |
| Molasses | 2.96 | 1.43 | 0.46 | 1.06 |
| Pressed Pulp (as DM) | 6.06 | 0.28 | — | 5.78 |

TABLE 4b
Enriched Pulp Model-pressed pulp with decreased draft
For every tonne of sugar beet:

| | |
|---|---|
| 152 | kg crystal sugar |
| 28 | kg molasses |
| 242 | kg pressed pulp |

Inputs

| | | | | |
|---|---|---|---|---|
| Beet sliced | 100.00 | 18.00 | 75.00 | 7.00 |
| Diffusion supply water | 17.45 | — | 17.45 | — |

Outputs

| | | | | |
|---|---|---|---|---|
| Raw Juice | 93.21 | 16.59 | 75.31 | 1.30 |
| Pressed Pulp | 24.24 | 1.41 | 16.97 | 5.87 |

Products

| | | | | |
|---|---|---|---|---|
| Sugar | 15.18 | 15.18 | — | — |
| Molasses | 2.76 | 1.34 | 0.43 | 0.99 |
| Pressed Pulp (as DM) | 7.27 | 1.41 | — | 5.87 |

TABLE 4c
Enriched Pulp Model-pressed pulp with decreased draft
and increased beet input
For every tonne of sugar beet:

| | |
|---|---|
| 146 | kg crystal sugar |
| 27 | kg molasses |
| 250 | kg pressed pulp |

| | | | |
|---|---|---|---|
| | Tonnes | Tonnes | Tonnes non |
| Tonnes | sugar | water | sugars |

Inputs

| | | | | |
|---|---|---|---|---|
| Beet sliced | 115.40 | 20.77 | 86.55 | 8.08 |
| Diffusion supply water | 16.61 | — | 16.61 | — |

Outputs

| | | | | |
|---|---|---|---|---|
| Raw Juice | 103.20 | 18.37 | 83.39 | 1.44 |
| Pressed Pulp | 28.81 | 2.40 | 19.59 | 6.82 |

Products

| | | | | |
|---|---|---|---|---|
| Sugar | 16.82 | 16.82 | — | 1 |
| Molasses | 3.06 | 1.48 | 0.48 | 1.10 |
| Pressed Pulp (as DM) | 9.22 | 2.40 | — | 6.82 |

From these models, it was predicted that the amount of native sugar content that can be retained in the beet pulp using the process of the invention may be increased by a factor of four, or higher, on a dry matter basis, as compared to a conventional sugar production operation. As an example, in the control model, native sugar made up approximately 4.5% of the dry matter in the pressed pulp, whereas in the enriched pulp model with the same amount of starting beet material, the native sugar made up nearly 20% of the dry matter in the pressed pulp. Increasing the amount of starting beet material similarly increased the amount of native sugar in the dry matter, at a level of over 25%. These data therefore support the conclusion that an enriched pulp feedstuff containing highly nutritive levels of native sugar from the beet source can be produced at a commercial scale using a conventional sugar production line.

### Example 4

To further investigate the operating parameters useful for producing the enriched pulp for animal feedstuff at a commercial scale, certain variables were tested on a commercial production line to provide results, which are summarized in Table IV.

For each trial, a quantity of sliced beet cossettes were fed into a conventional commercial scale sugar production diffuser apparatus, such as a conventional continuous counter current extractor. Examples of such extractors include, but are not limited to, a DDS Diffuser or a Tower Diffuser. Water is supplied in an amount sufficient for the apparatus to properly function, and in each particular case, in an amount to achieve the draft percent target, as described in the following tables.

TABLE 5a
Trial 1: Control pressed pulp production
For every kg of sugar beet: 0.27 kg of pressed pulp

| | | | |
|---|---|---|---|
| kg | kg sugar | kg water | kg non sugars |

Inputs

| | | | | |
|---|---|---|---|---|
| Beet sliced | 765.00 | 112.84 | 604.35 | 47.81 |
| Diffusion supply water | 690.00 | — | 690.00 | — |

Outputs

| | | | | |
|---|---|---|---|---|
| Raw Juice | 795.00 | 97.79 | 687.28 | 9.94 |
| Pressed Pulp | 208.70 | 4.90 | 170.61 | 33.18 |

Products

| | | | | |
|---|---|---|---|---|
| Pressed Pulp (as DM) | 38.09 | 4.90 | — | 33.18 |

TABLE 5b
Trial 2a: Pressed pulp production with reduced draft
For every kg of sugar beet: 0.32 kg of pressed pulp

| | | | |
|---|---|---|---|
| kg | kg sugar | kg water | kg non sugars |

Inputs

| | | | | |
|---|---|---|---|---|
| Beet sliced | 700.00 | 107.80 | 543.55 | 48.65 |
| Diffusion supply water | 599.40 | — | 599.40 | — |

Outputs

| | | | | |
|---|---|---|---|---|
| Raw Juice | 692.00 | 94.46 | 589.24 | 8.30 |
| Pressed Pulp | 224.00 | 6.61 | 184.02 | 33.38 |

Products

| | | | | |
|---|---|---|---|---|
| Pressed Pulp (as DM) | 39.98 | 6.61 | — | 33.38 |

TABLE 5c
Trial 2b: Pressed pulp production with reduced draft
For every kg of sugar beet: 0.24 kg of pressed pulp

| | | | |
|---|---|---|---|
| kg | kg sugar | kg water | kg non sugars |

Inputs

| | | | | |
|---|---|---|---|---|
| Beet sliced | 756.00 | 114.91 | 593.08 | 48.01 |
| Diffusion supply water | 636.60 | — | 636.60 | — |

Outputs

| | | | | |
|---|---|---|---|---|
| Raw Juice | 722.00 | 90.97 | 621.64 | 9.39 |
| Pressed Pulp | 184.54 | 7.29 | 149.94 | 27.31 |

Products

| | | | | |
|---|---|---|---|---|
| Pressed Pulp (as DM) | 34.60 | 7.29 | — | 27.31 |

TABLE 5d
Trial 2c: Pressed pulp production with reduced draft
For every kg of sugar beet: 0.33 kg of pressed pulp

| | | | |
|---|---|---|---|
| kg | kg sugar | kg water | kg non sugars |

Inputs

| | | | | |
|---|---|---|---|---|
| Beet sliced | 698.00 | 116.92 | 537.81 | 43.28 |
| Diffusion supply water | 556.20 | — | 556.20 | — |

Outputs

| | | | | |
|---|---|---|---|---|
| Raw Juice | 672.36 | 98.16 | 566.46 | 7.73 |
| Pressed Pulp | 231.00 | 7.39 | 188.84 | 34.77 |

Products

| | | | | |
|---|---|---|---|---|
| Pressed Pulp (as DM) | 42.16 | 7.39 | — | 34.77 |

TABLE 5e
Trial 3: Pressed pulp production with reduced temperature and draft
For every kg of sugar beet: 0.27 kg of pressed pulp

| | | | |
|---|---|---|---|
| kg | kg sugar | kg water | kg non sugars |

Inputs

| | | | | |
|---|---|---|---|---|
| Beet sliced | 994.00 | 151.09 | 786.25 | 56.66 |
| Diffusion supply water | 624.00 | — | 624.00 | — |

Outputs

| | | | | |
|---|---|---|---|---|
| Raw Juice | 798.80 | 105.44 | 673.39 | 19.97 |
| Pressed Pulp | 264.46 | 14.81 | 208.26 | 41.39 |

Products

| | | | | |
|---|---|---|---|---|
| Pressed Pulp (as DM) | 56.20 | 14.81 | — | 41.39 |

TABLE 5f
Trial 4: Pressed pulp production with reduced temperature
For every kg of sugar beet: 0.25 kg of pressed pulp

| | | | |
|---|---|---|---|
| kg | kg sugar | kg water | kg non sugars |

Inputs

| | | | | |
|---|---|---|---|---|
| Beet sliced | 761.00 | 125.57 | 587.49 | 47.94 |
| Diffusion supply water | 672.60 | — | 672.60 | — |

Outputs

| | | | | |
|---|---|---|---|---|
| Raw Juice | 811.00 | 100.56 | 701.52 | 8.92 |
| Pressed Pulp | 189.33 | 7.67 | 149.67 | 32.00 |

Products

| | | | | |
|---|---|---|---|---|
| Pressed Pulp (as DM) | 39.66 | 7.67 | — | 32.00 |

TABLE 5g
Trial 5: Pressed pulp production with reduced Silin Number
For every kg of sugar beet: 0.30 kg of pressed pulp

| | | | |
|---|---|---|---|
| kg | kg sugar | kg water | kg non sugars |

Inputs

| | | | | |
|---|---|---|---|---|
| Beet sliced | 742.00 | 119.83 | 579.50 | 42.67 |
| Diffusion supply water | 648.60 | — | 648.60 | — |

Outputs

| | | | | |
|---|---|---|---|---|
| Raw Juice | 753.60 | 99.85 | 644.70 | 9.04 |
| Pressed Pulp | 220.36 | 9.03 | 180.14 | 31.18 |

Products

| | | | | |
|---|---|---|---|---|
| Pressed Pulp (as DM) | 40.22 | 9.03 | — | 31.18 |

The data generated in each trial are summarized in the following table.

TABLE 6

| | | | | | | Cossettes as supplied | | | |
|---|---|---|---|---|---|---|---|---|---|
| Trial No. | | | | Pressed Pulp | | to diffuser | | Raw Juice | |
| And | Draft | Temp | Silin | DM | Sugar | DM | Sugar | DM | Sugar |
| Variable | (%) | ° C. | No. | (%) | (%) | (%) | (%) | (%) | (%) |
| 1. Control | 103.9 | 71.8 | 6.56 | 18.25 | 2.35 | 20.95 | 14.75 | 13.55 | 12.30 |
| 2a. Draft I | 98.9 | 72.2 | 5.62 | 17.85 | 2.95 | 22.35 | 15.40 | 14.85 | 13.65 |
| 2b. Draft II | 95.5 | 72.1 | 5.73 | 18.75 | 3.95 | 21.55 | 15.20 | 13.90 | 12.60 |
| 2c. Draft III | 96.3 | 71.6 | 4.90 | 18.25 | 3.20 | 22.95 | 16.75 | 15.75 | 14.60 |
| 3. Temp + | 80.4 | 68.5 | 8.50 | 21.25 | 5.60 | 20.90 | 15.20 | 15.70 | 13.20 |
| Draft | | | | | | | | | |
| 4. Temp | 106.6 | 64.1 | 6.30 | 20.95 | 4.05 | 22.80 | 16.50 | 13.50 | 12.40 |
| 5. Silin No. | 101.6 | 71.0 | 3.30 | 18.25 | 4.10 | 21.90 | 16.15 | 14.45 | 13.25 |

From these data, a number of observations regarding the process of the invention may be noted.

As noted previously, in a conventional process, the draft is preferably greater than 100% of the weight of the cossettes provided to the diffuser apparatus. However, it was unexpectedly discovered that operating at a diffuser draft of 100% or less, it was possible to produce a pulp at a commercial scale, having a higher native sugar content in the pressed pulp, and suitable for use as an animal feedstuff. The reduced draft can range from about 75% to about 100%, including about 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, and 100%.

In one aspect, reducing the diffuser draft from about 104% to about 96% resulted in a beet pulp having a 68% higher native sugar content in the pressed pulp following extraction.

In another aspect, although conventionally, higher temperatures are preferred in the diffuser apparatus to facilitate cellular structure denaturation leading to sugar release, it was unexpectedly discovered that operating at lower temperatures provides sufficient energy to produce a pulp from the beet source in the diffuser apparatus while retaining a higher native sugar content in the beet pulp. For example operating at a diffuser temperature ranging from about 55° C. to about 75° C., including about 55° C., 56° C., 57° C., 58° C., 59° C., 60° C., 61° C., 61° C., 63° C., 64° C., 65° C., 66° C., 67° C., 68° C., 69° C., 70° C., 71° C., 72° C., 73° C., 74° C., and 75° C. results in achieving the desired native sugar content in the beet pulp.

In another aspect, reducing the diffuser temperature from 72° C. to 64° C. resulted in the beet pulp having a 72% higher native sugar content in the pressed pulp following extraction.

Combining a decrease in diffuser temperature and a decrease in diffuser draft resulted in a synergistic effect, providing an unexpected increase in native sugar content in the pressed pulp. For example, reducing the diffuser temperature from about 72° C. to about 69° C., and the draft from about 104% to about 80%, resulted in a 138% increase in the native sugar content of the pressed pulp following extraction.

Another operating parameter that may be controlled to achieve the higher native sugar content in the beet pulp is the Silin Number denoting the thickness of the beet cossette. It was unexpectedly discovered that cossettes having a lower Silin Number—namely, that are thicker—than conventional cossettes are suitable, or preferred, for use in the process of the invention to provide the desired native sugar content in the produced feedstuff. Typical Silin Numbers in a conventional process range from about 7 to about 20. It was found that lower Silin Numbers, ranging from about 1 to about 6, and including 1, 2, 3, 4, 5, and 6, are suitable for achieving the desired result of retaining more of the native sugar content in the pulp as compared to a conventional process.

In another aspect, reducing the Silin Number from 6.6 to 3.3 led to a 75% increase in native sugar content in the beet pulp following extraction.

As noted previously, retention time, or system throughput, is another operating parameter which is affected by at least the three parameters described above. In a conventional process, the retention time in the diffuser apparatus is about 60 in a horizontal diffuser, or about 120 minutes in a vertical diffuser. It was unexpectedly discovered that retention times in accordance with the invention can range from about 20 minutes to about 55 minutes in a horizontal diffuser, or between 60 minutes to 110 minutes in a vertical diffuser, depending on the factors described above.

From the foregoing, it can be seen that the draft and the diffuser operating temperature have an impact on the amount of native sugar content that can be retained in the beet pulp following processing in the diffuser apparatus. In some embodiments, the sugar content may range from about 5% by weight of the dry matter to about 45% by weight of the dry matter, preferably from about 10% to about 45% by weight of the dry matter, and more preferably from about 20% to about 45% by weight of the dry matter. The process to achieve these native sugar content levels can be further optimized synergistically by making additional adjustments to the Silin Number, as well as retention time, as will be well understood by those skilled in the art.

While several possible aspects are disclosed above, embodiments of the present invention are not so limited. These exemplary aspects are not intended to be exhaustive or to unnecessarily limit the scope of the invention, but instead were chosen and described in order to explain the principles of the present invention so that others skilled in the art may practice the invention. Indeed, various modifications of the invention in addition to those described herein will become apparent to those skilled in the art from the foregoing description. Such modifications are intended to fall within the scope of the appended claims. The present invention is, in particular, captured by any one or any combination of one or more of the above-mentioned aspects, with any other statement and/or embodiments.

1. A process for making an enriched sugarbeet pulp composition comprising the steps of:
a. providing a crop comprising Beta vulgaris plants or parts thereof having a dry matter content greater than about 18% by weight;
b. cutting the crop into pieces;
c. conveying the pieces into a diffusion apparatus to produce a fluid and a pulp, said pulp comprising a native sugar content of about 15% to about 60% by weight of the dry matter of the pulp;
d. removing the pulp from the diffusion apparatus; and
e. processing the pulp to form the enriched sugarbeet pulp composition;
optionally further comprising the step of analyzing the crop to determine a sugar concentration of the crop, preferably wherein the sugar concentration of the crop is determined after cutting the crop into pieces;
optionally further after removing the pulp from the diffusion apparatus, the pulp is pressed to form a pressed pulp, preferably wherein the pressed pulp is dried to form a dried pulp, more preferably the dried pulp is pelletized and/or the dried pulp is in the form of shreds;
optionally further comprising the step of analyzing the pulp to determine a sugar concentration of the pulp.

2. The process of claim 1, wherein the sugar concentration of the crop and/or the pulp is determined by spectrometry, preferably wherein the spectrometry is performed by a spectroscopic method selected from the group consisting of: infrared spectroscopy; midinfrared spectroscopy; near infrared spectroscopy; Raman spectroscopy; hyperspectral imaging; refractometry; polarimetry; and a combination thereof.

3. An enriched sugarbeet pulp composition made by the process of claim 1.

4. The enriched sugarbeet pulp composition of claim 3, wherein the dry matter content of the composition is between about 5 and 95% by weight, or wherein the dry matter content of the composition is between about 30-85% by weight.

5. The enriched sugarbeet pulp composition of claim 3, wherein the sugar content of the composition is between about 0 and 60% by weight, or wherein the sugar content of the composition is between about 0 and 30% by weight.

6. The enriched sugarbeet pulp composition of claim 3, further comprising a nutritional component, preferably wherein the nutritional component comprises a digestible fiber, more preferably wherein the digestible fiber comprises pectin.

7. (canceled)

8. An enriched sugarbeet pulp animal composition comprising from about 5% to about 95% processed Beta vulgaris dry matter, wherein the dry matter comprises from about 0% to about 60% sugar, preferably wherein the dry matter further comprises from about 0% to about 100% by weight digestible fiber.

9. The enriched sugarbeet pulp composition of claim 8, wherein the digestible fiber comprises from about 0% to about 100% by weight pectin, preferably wherein the ratio of the sugar to the pectin in the composition ranges from about 1 to about 100% by weight.

10. (canceled)

11. A system for managing throughput in a production facility for processing a sugar-containing crop material, comprising;
a. a first detection apparatus to detect a dry matter content and sugar content of the crop material;
b. a second detection apparatus in communication with a fluid-based diffusion apparatus to detect a processed sugar content of the fluid within the diffusion apparatus when the crop material is in the diffusion apparatus, said diffusion apparatus having at least a plurality of operational modes;
c. a controller for controlling the operation of diffusion apparatus in each operational mode; and
d. a memory and processor configured to:
i. receive the dry matter content and the processed sugar content from the first and second detectors;
ii. compare the dry matter content and the processed sugar content; iii. generate a comparison value;
iv. determine whether the comparison value meets a threshold processed sugar yield target; and
v. transmit a signal to the controller for maintaining or changing the operational mode of the diffusion apparatus based on the determination step (iv).

12. The system of claim 11, wherein the threshold processed sugar yield target is generated by a second processor, preferably wherein the second processor is configured to:
a. receive a weight input indicating the quantity of the crop material;
b. receive the dry matter content and sugar content from the first detection apparatus; and
c. determine the threshold processed sugar yield target based on the weight input and the dry matter content.

13. The system of claim 11, wherein the first detection apparatus comprises a measurement apparatus for measuring a raw sugar content of the crop material, preferably wherein the measurement apparatus uses spectrometry to measure the raw sugar content.

14. The system of claim 13, wherein the spectrometry is done by a spectroscopic method selected from the group consisting of: infrared spectroscopy; mid-infrared spectroscopy; near infrared spectroscopy; Raman spectroscopy; hyperspectral imaging; refractometry; polarimetry; and a combination thereof.

15. The system of claim 11, further comprising a third detection apparatus in communication with the diffusion apparatus to detect a crude protein content of a pulp formed from the crop material within the diffusion apparatus.
